(19) United States
(12) Patent Application Publication
(10) Pub. No.: US 2004/0155773 A1
(43) Pub. Date: Aug. 12, 2004

(54) System and method for detecting whether a human being, object or animal has moved beyond a predetermined radius

(76) Inventors: Hal Russell, Shrewsbury, MA (US); Don Corey, Charlton, MA (US); Rodney Miller, Westmount (CA)

Correspondence Address: MCDERMOTT WILL & EMERY LLP, 600 13TH STREET, N.W., WASHINGTON, DC, 20005-3096, US

(21) Appl. No.: 10/364,671

(22) Filed: Feb. 12, 2003

(51) Int. Cl. G08B 1/08

(52) U.S. Cl. 340/539.21; 340/573.4; 340/573.3

(57) ABSTRACT

Disclosed is a system for determining if a human being, object or animal has moved beyond a predetermined radius. The system includes a base station, and at least one slave associated with the base station. Each of the slaves is located on the human being, object or animal, and each slave is adapted to receive and emit a coded signal at predetermined intervals. The base station is adapted to transmit and receive the coded signal, decode the coded signal and, if the coded signal represents a slave associated with the base station, determine a signal strength of the coded signal, the signal strength of the coded signal indicating that the human being, object or animal has moved beyond a predetermined area if the signal strength is below a predetermined threshold.

### FIELD OF THE INVENTION

The present invention relates to a system and method for detecting whether a human being, object or animal has moved beyond a predetermined radius.

### DESCRIPTION OF THE PRIOR ART

One of the main concerns of pet owners is the risk the pet wanders out of range, and may be lost forever. It is thus traditional, particularly in urban areas, that pet owners build a fence around their property in order to contain the family pet or pets. Such fences are expensive to build, and may not always successfully contain animals such as cats, which are more agile than dogs. On the other hand, dogs may dig under the fence and escape that way.

In order to alleviate this problem, there has been developed what is known as an “electronic fence.” Such a system requires the burial of a wire around the perimeter. The pet is equipped with a receiver, which receives a low frequency signal emitted by the wire. When the pet comes within a predetermined distance of the wire, generally two to three feet, an audible correction tone is emitted by the receiver, alerting the pet that it has come too close to the perimeter. Such systems have met with mitigated success, and one of the major drawbacks is the burying of the wire. Another drawback of such systems is that they are inherently fixed, and thus inflexible, both in terms of location and movement restrictions.

There is thus a need to provide a system which would give a pet owner early warning that the pet has moved beyond the authorized radius. Such a system could also find application to objects, as well as human beings. There is also a need to make the system portable or mobile, and to allow for variation or adjustment of the predetermined radius to suit the user's needs of the moment.

### SUMMARY OF THE INVENTION

It is an object of the invention to provide a system for determining if a human being, object or animal has moved beyond a predetermined radius, which is economical and does not require physical components to be installed or buried. In accordance with the invention, this object is achieved with a system comprising:

a base station, and at least one slave associated with said base station, each of said at least one slave being located on said human being, object or animal, wherein each of said at least one slave is adapted to receive and emit a coded signal at predetermined intervals, and wherein said base station is adapted to transmit and receive said coded signal, decode said coded signal and, if said coded signal represents a slave associated with said base station, determine a signal strength of said coded signal, said signal strength of said coded signal indicating that the human being, object or animal has moved beyond a predetermined area if said signal strength is below a predetermined threshold.

In accordance with another aspect of the invention, there is provided a system comprising:

a base station, said base station including an antenna, an input/output unit, a central processing unit, a controller, a clock, an encryption unit and power means, said base station being configured to receive a coded signal from a slave unit, to calculate a signal strength of said coded signal and to compare said signal strength of said coded signal with a predetermined reference level;

at least one slave unit, each of said at least one slave unit including an antenna, an input/output unit, controller, a clock, an encryption unit and power means, said slave unit outputting said coded signal coded with said encryption unit at predetermined intervals.

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic representation of a base station according to a preferred embodiment of the invention;

FIG. 2 is a schematic representation of a slave unit according to a preferred embodiment of the invention; and

FIG. 3 is a representation of the system according to a preferred embodiment of the invention, where the slave unit is incorporated into a dog collar of a dog.

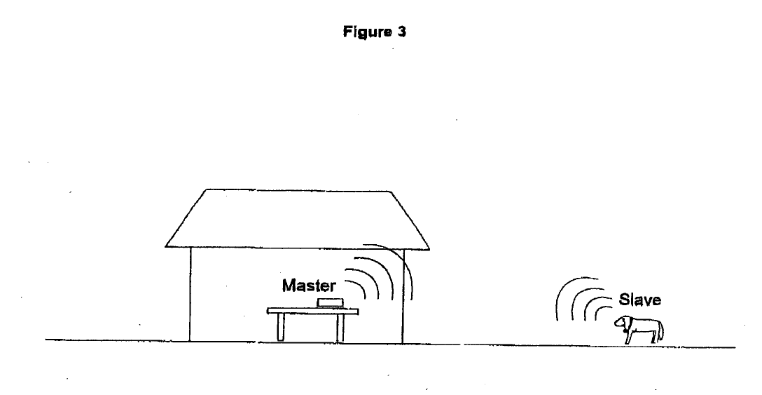

### DESCRIPTION OF A PREFERRED EMBODIMENT OF THE INVENTION

The present invention concerns a system for determining if a human being, object or animal has moved beyond a predetermined radius. The system in its most basic expression includes a base station 10 and at least one slave unit 50.

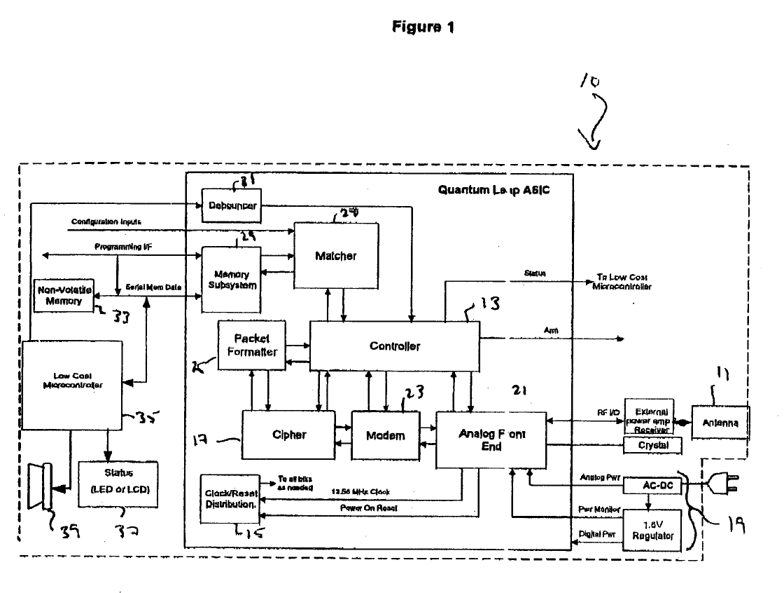

The base station 10, schematically shown in FIG. 1, is configured to transmit, encrypted coded data, challenges to the slave unit 50. Upon receipt of the unique encrypted coded signal, the slave unit 50 decodes the signal provided it is within a predetermined RF acceptance range. If the slave unit 50 authenticates this challenge by matching a stored ID value in its local Non-Volatile Memory it will send a coded response back to the base station 10. The challenge response signal, when received by the base unit 10, is decoded and, if the signal received matches that of an associated slave unit, and the monitored signal strength is above a predetermined level no corrective action will be initiated by the base station 10. If the signal strength is below the predetermined threshold and the base station cannot validate the challenge response from the slave this will be an indication that the slave unit is out of range. Based on this determination, remedial action may be taken. For example, a visual or audible alarm can be activated at the base station. Additionally, or alternatively, a second coded signal can be sent from the base station to the slave unit, which signal, upon receipt, triggers an audible alarm at the slave unit.

Referring now to FIG. 1, the components of the base station will be detailed. The base station 10 includes an antenna 11, an input/output unit, a controller 13, a clock 15, an encryption unit 17, a microcontroller 35 and power means 19. Preferably, the power means 19 are an AC source, but the power means could also be provided with a battery back-up.

Of course, other components shown in FIG. 1 can be used based on the particular design, but variations are well within the skill of a person skilled in this art. For the purposes of the present description, all components illustrated will be described in broad terms, and the presence or absence of such components should not be considered as being limitative. Thus, the base station may include an analog front end module 21 for interfacing between the antenna 11, power source 19, clock 15, modem responsible for modulating and demodulating the encoded and decoded signals 23 and a controller that manages and oversees all the functional building blocks 13. The encryption unit 17 or Cipher main function is to convert native data to encrypted data and convert encrypted data from the slave 50 to native data received by the base station 10. The packet formatter 25 is responsible for assembling and dissembling transmitted and received data under controller 13 supervision. The matcher 27 compares the received data with data stored in Non-Volatile Memory 33 as defined by the user. In order to appropriately maintain in memory the parameters of the base station and any associated slave units, a programming memory interface 33 is provided. A suitable microcontroller 35 provides the necessary intelligence to control the correction speaker or alarm 39 and maintain optional threshold settings while providing realtime status update to a display 37. The matcher is also provided with a configuration input, to allow for variable operational configurations to the base unit 10.

Each slave unit 50 is adapted to receive and respond to a coded signal at predetermined time intervals set by the base station 10. Each slave unit includes an antenna 51, an input/output unit, a controller 53, a clock 55, and encryption unit 57 and power means 59. In a preferred embodiment, the power means 59 are a small battery.

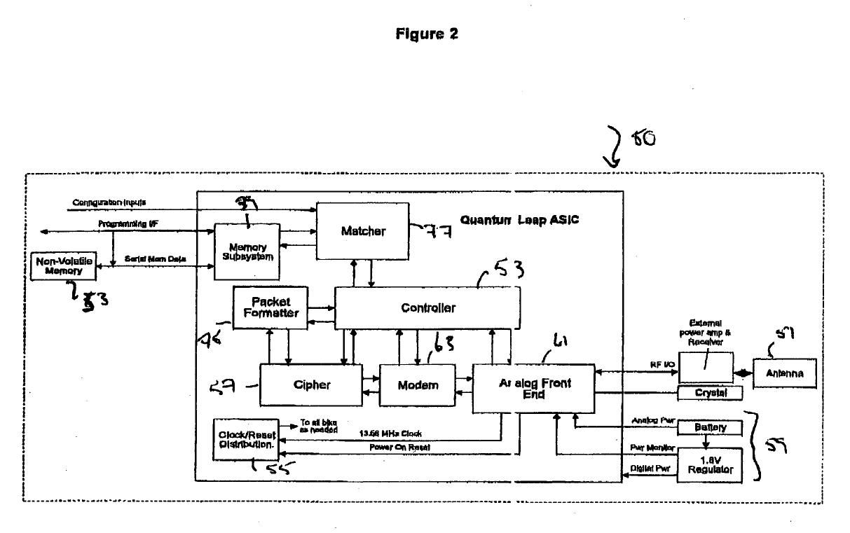

Of course, other components shown in FIG. 2 can be used based on the particular design, but variations are well within the skill of a person skilled in this art. For the purposes of the present description, all components illustrated will be described in broad terms, and the presence or absence of such components should not be considered as being limitative. Thus, each slave unit 50 may include an analog front end module 61 for interfacing between the antenna 51, power source 59, clock 55, modem 63 and controller 53. The encryption unit 57 is operatively connected to controller 53 and packet formatter 75. In order to appropriately maintain in memory the parameters of each associated slave units, memory 79 a programming memory interface are provided. As is the case with the Base unit 10 the matcher 77 compares the received data with ID and configuration data stored in Non-Volatile Memory as defined by the user. The matcher is also provided with a configuration input, to allow for variable operational configurations to the slave unit 50.

In use, the base station 10 is located at a fixed location, such as inside a house or with a person in authority when used in mobile battery operation. The base station 10 transmits a coded challenge signal at predetermined times. The signal is preferably continuously emitted, at intervals that will allow for the appropriate response times to allow for proper detection of out of area slave units 50. Once the slave unit 50 receives the challenge, if the slave unit 50 Matcher validates the base stations challenge it sends a challenge response back to the base unit 10. In order to avoid conflicts with slave units from un-associated base stations, and in order to avoid collisions between two slave units associated with a given base station, the encoding is preferably unique to each slave unit. When the signal is decoded, and it is determined that the base station receives a correct signal, the strength of the received coded signal is compared with a reference signal. If the strength of the coded signal is below the reference signal, the slave unit has moved beyond the predetermined perimeter. An alarm, visual or audible, or both, can be activated on the base station to alert the appropriate persons. Advantageously, the display on the base station can also display a relative distance between the base station and a slave unit, by calculating a ratio of signal strength over the predetermined reference. Time-delay of arrival could also be used to calculate distance.

In a preferred embodiment, when the slave unit has moved beyond the predetermined area, the base station encodes a signal that is broadcast. The appropriate slave unit receives the broadcast, decodes the signal, and if the signal is destined to the slave unit, activates an audible alarm forming part of the slave unit. This gives indication that the slave unit has moved beyond the predetermined area. This permits not only monitoring, but audible warning to an animal to return closer to the base station.

As mentioned above, the present system can be used particularly advantageously for pets, and specifically dogs. Dogs also respond to audible alarms. However, the system can be used for objects, such as high-value objects in order to deter/prevent theft. Such systems could also be used to prevent wandering of children, or individuals suffering from conditions such as Alzheimer's disease.

Advantages of the system of the present invention, if used for pets, is that the system can complement an electronic fence system, and in some cases replace it entirely.

Although the present invention has been explained herein above by way of a preferred embodiment thereof, it should be pointed out that any modifications to this preferred embodiment within the scope of the appended claims is not deemed to alter or change the nature and scope of the present invention.

1. A system for determining if a human being, object or animal has moved beyond a predetermined radius comprising:
a base station, and at least one slave associated with said base station, each of said at least one slave being located on said human being, object or animal, wherein each of said at least one slave is adapted to receive and emit a coded signal at predetermined intervals, and wherein said base station is adapted to transmit and receive said coded signal, decode said coded signal and, if said coded signal represents a slave associated with said base station, determine a signal strength of said coded signal, said signal strength of said coded signal indicating that the human being, object or animal has moved beyond a predetermined area if said signal strength is below a predetermined threshold.

2. A system according to claim 1, wherein said base station further includes an audible alarm triggered when said signal strength is below a predetermined threshold.

3. A system according to claim 2, wherein each of said at least one slave further includes an audible alarm, said audible alarm being triggered by a coded signal emitted by said base station when said signal strength is below a predetermined threshold.

4. A system for determining when a human being, object or animal has moved beyond a predetermined radius, said system comprising:
a base station, said base station including an antenna, an input/output unit, a central processing unit, a controller, a clock, an encryption unit and power means, said base station being configured to receive a coded signal from a slave unit, to calculate a signal strength of said coded signal and to compare said signal strength of said coded signal with a predetermined reference level;
at least one slave unit, each of said at least one slave unit including an antenna, an input/output unit, controller, a clock, an encryption unit and power means, said slave unit outputting said coded signal coded with said encryption unit at predetermined intervals.

5. A system according to claim 4, wherein said base station further includes visual or audible means triggered when said signal strength of said coded signal is below said predetermined reference level.

6. A system according to claim 4, wherein said slave unit further includes an audible alarm, and wherein said base station is adapted to emit a coded signal indicative of signal strength below said predetermined reference level, said audible alarm of said slave unit being triggered when said coded signal indicative of signal strength below said predetermined reference level is received by said slave unit.

7. A system according to claim 4, wherein said system includes a plurality of slave units, each of said plurality of slave units coding said coded signal with a different code.
